(19) United States
(12) Patent Application Publication
(10) Pub. No.: US 2025/0150373 A1
(43) Pub. Date: May 8, 2025

(54) NETWORK BANDWIDTH ESTIMATION METHOD AND APPARATUS, AND ELECTRONIC DEVICE AND STORAGE MEDIUM

(71) Applicant: BEIJING BYTEDANCE NETWORK TECHNOLOGY CO., LTD., Beijing (CN)

(72) Inventors: Liyang SUN, Los Angeles, CA (US); Mingming SHEN, Beijing (CN); Lei ZHAI, Beijing (CN); Hao DONG; Qian MA, Beijing (CN)

(21) Appl. No.: 18/836,740

(22) PCT Filed: Feb. 6, 2023
(86) PCT No.: PCT/CN2023/074527

§ 371 Date: Aug. 7, 2024

(30) Foreign Application Priority Data
Feb. 8, 2022 (CN) 202210117416.6

(51) Int. Cl. H04L 43/0894; H04L 41/16; H04L 43/0864; H04L 43/50

(52) U.S. Cl. CPC H04L 43/0894; H04L 41/16; H04L 43/0864; H04L 43/50

(57) ABSTRACT

A network bandwidth estimation method and apparatus, an electronic device and a storage medium are provided. The method includes: sending a bandwidth test file to a service terminal, and respectively acquiring network state parameters before and after sending the bandwidth test file, wherein a volume of the bandwidth test file is less than a preset file volume threshold; determining a first network bandwidth and a second network bandwidth based on the network state parameters and the volume of the bandwidth test file; inputting the network state parameters, the first network bandwidth, and the second network bandwidth into a current latest network bandwidth estimation model to obtain a target network bandwidth estimation result.

The present application claims the priority to the Chinese Patent Application No. 202210117416.6, filed on Feb. 8, 2022, to the Chinese Patent Office, the entire content of which is incorporated herein by reference.

### TECHNICAL FIELD

The present disclosure relates to the technical field of data communication, for example, to a network bandwidth estimation method, apparatus, system, electronic device and storage medium.

### BACKGROUND

In the process of a user posting a video, the video application platform edits and processes the video and finally uploads and posts the video to the service terminal. Among them, video editing usually adopts dynamic coding strategy, and the coding strategy of the video is determined according to the prediction result of an uploading network bandwidth, so that the video posting process is streamlined and the user's experience in the video uploading process is improved.

In order to probe the upload network bandwidth, speed measurement data need to be sent before the formal video upload, and the data volume of the speed measurement data is small. However, the upload speed measurement of small data volume is limited by the transport layer protocol, and the speed measurement result is inaccurate, which leads to the determined video coding strategy is not an optimal strategy. Due to the different coding strategies of videos, there will be different coding durations and uploading durations, which may affect the user experience in the process of video uploading, and even affect the viewing experience of the video.

### SUMMARY

The present disclosure provides a network bandwidth estimation method, apparatus, system, electronic device and storage medium, capable of achieving improving accuracy of a network speed measurement result, to better match a better video coding strategy for a video to be uploaded, and improve the user experience sense of video uploading.

An embodiment of the present disclosure provides a network bandwidth estimation method, applied to a client, including:
sending a bandwidth test file to a service terminal, and respectively acquiring network state parameters before and after sending the bandwidth test file, wherein a volume of the bandwidth test file is less than a preset file volume threshold;
determining a first network bandwidth and a second network bandwidth based on the network state parameters and the volume of the bandwidth test file;
inputting the network state parameters, the first network bandwidth, and the second network bandwidth into a current latest network bandwidth estimation model to obtain a target network bandwidth estimation result;
wherein the current latest network bandwidth estimation model is a model determined based on machine learning of the network state parameters, the first network bandwidth, the second network bandwidth, and an actual network bandwidth corresponding to the target network bandwidth estimation result in historical network bandwidth estimation processes.

An embodiment of the present disclosure further provides a network bandwidth estimation method, applied to a service terminal, including:
acquiring network state parameters collected, a first network bandwidth and a second network bandwidth obtained by calculation, and an actual network bandwidth corresponding to a target network bandwidth estimation result, in each network bandwidth estimation process by a client, as model training sample data;
training a network bandwidth estimation model based on the model training sample data; sending the trained network bandwidth estimation model to the client, so that the client estimates a target network bandwidth estimation result based on the network bandwidth estimation model.

An embodiment of the present disclosure further provides a network bandwidth estimation apparatus configured at a client, including:
a test data acquisition module, configured to send a bandwidth test file to a service terminal, and respectively acquire network state parameters before and after sending the bandwidth test file, wherein a volume of the bandwidth test file is less than a preset file volume threshold;
a first bandwidth estimation module, configured to determine a first network bandwidth and a second network bandwidth based on the network state parameters and the volume of the bandwidth test file;
a second bandwidth estimation module, configured to input the network state parameters, the first network bandwidth, and the second network bandwidth into a current latest network bandwidth estimation model to obtain a target network bandwidth estimation result;
wherein the current latest network bandwidth estimation model is a model determined based on machine learning of the network state parameters, the first network bandwidth, the second network bandwidth, and an actual network bandwidth corresponding to the target network bandwidth estimation result in historical network bandwidth estimation processes.

An embodiment of the present disclosure further provides a network bandwidth estimation apparatus configured at a service terminal, including:
a model training sample acquiring module, configured to acquire network state parameters collected, a first network bandwidth and a second network bandwidth obtained by calculation, and an actual network bandwidth corresponding to a target network bandwidth estimation result, in each network bandwidth estimation process by a client, as model training sample data;
a model training module, configured to train a network bandwidth estimation model based on the model training sample data;
a bandwidth estimation module, configured to send the trained network bandwidth estimation model to the client, so that the client estimates a target network bandwidth estimation result based on the network bandwidth estimation model.

An embodiment of the present disclosure further provides an electronic device, including:
at least one processor;
a storage apparatus configured to store at least one program,
the at least one program, when executed by the at least one processor, causes the at least one processor to implement a network bandwidth estimation method according to any one of the embodiments of the present disclosure.

Embodiments of the present disclosure also provide a storage medium containing computer-executable instructions, the computer-executable instructions, when executed by a computer processor, are used to perform the network bandwidth estimation method according to any one of the embodiments of the present disclosure.

### BRIEF DESCRIPTION OF DRAWINGS

FIG. 1 is a flowchart diagram illustrating a network bandwidth estimation method applied to a client according to Embodiment 1 of the present disclosure;

FIG. 2 is a flowchart diagram illustrating a network bandwidth estimation method applied to a client according to Embodiment 2 of the present disclosure;

FIG. 3 is a flowchart diagram illustrating a network bandwidth estimation method applied to a client according to Embodiment 3 of the present disclosure;

FIG. 4 is a flowchart diagram illustrating a network bandwidth estimation method applied to a client according to Embodiment 4 of the present disclosure;

FIG. 5 is a flowchart diagram illustrating a network bandwidth estimation method applied to a service terminal according to Embodiment 5 of the present disclosure;

FIG. 6 is a block diagram of a network bandwidth estimation apparatus configured at a client according to Embodiment 6 of the present disclosure;

FIG. 7 is a block diagram of a network bandwidth estimating apparatus configured at a service terminal according to Embodiment 7 of the present disclosure;

FIG. 8 is a structural schematic diagram of an electronic device according to Embodiment 8 of the present disclosure.

### DETAILED DESCRIPTION

Embodiments of the present disclosure will be described below with reference to the accompanying drawings. While some embodiments of the present disclosure are illustrated in the accompanying drawings, the present disclosure may be embodied in many forms and should not be construed as limited to the embodiments set forth herein, but rather, these embodiments are provided for understanding of the disclosure. The drawings and embodiments of the present disclosure are for exemplary purposes only, and are not intended to limit the scope of protection of the present disclosure.

The multiple steps recited in the method implementation of the present disclosure may be performed in a different order, and/or in parallel. Further, the method implementation may include additional steps and/or omit performing illustrated steps. The scope of the present disclosure is not limited in this regard.

As used herein, the term “include” and variations thereof are open inclusion, that is, “including, but not limited to”. The term “based on” is “based at least in part on.” The term “one embodiment” means “at least one embodiment”; The term “another embodiment” means “at least one additional embodiment”; The term “some embodiments” means “at least some embodiments”. Relevant definitions for other terms will be given in the description below.

The concepts of “first”, “second”, and the like mentioned in the present disclosure are only used to distinguish different apparatuses, modules, or units, and are not used to limit the order or interdependence of functions performed by these apparatuses, modules, or units.

Modifications in the present disclosure that refer to “a”, “a plurality” are intended to be illustrative rather than limiting, and should be understood to mean “one or more” unless the context dictates otherwise.

### Embodiment 1

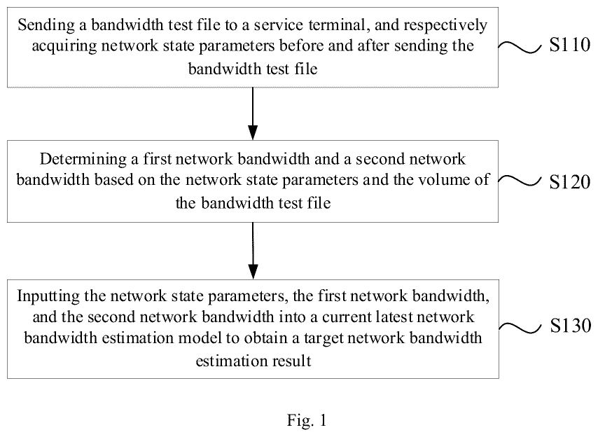

FIG. 1 is a flowchart diagram illustrating a network bandwidth estimation method applied to a client according to Embodiment 1 of the present disclosure. The embodiment of the present disclosure is suitable for a scenario where network bandwidth is rapidly tested, for example, it is suitable for a situation of bandwidth prediction before the user uploads the video to determine the video dynamic coding strategy. The method may be performed by a network bandwidth estimation apparatus configured at a client, which may be implemented in the form of software and/or hardware. The apparatus may be configured in an electronic device, such as a mobile terminal or a server device.

As shown in FIG. 1, the present embodiment provides a network bandwidth estimation method applied to a client, comprising the following steps.

S110, sending a bandwidth test file to a service terminal, and respectively acquiring network state parameters before and after sending the bandwidth test file.

When a user posts a video through some social media applications or short video applications, the video will be edited, processed, and finally uploaded. Accordingly, in order to improve the user experience, the application client may encode and compress an edited video to be post in the video uploading process. A strategy of coding and compression is a dynamic coding strategy according to the result of the client's prediction of the upload network bandwidth condition.

After the user triggers the video upload, the client sends the speed measurement data before uploading the video to be posted in order to predict the upload network bandwidth. That is, the client establishes a speed measurement connection with the service terminal and sends a bandwidth test file to the service terminal. Among them, the bandwidth test file itself is a file with very small data amount, the volume of the bandwidth test file is smaller than the preset file volume threshold, and the content of the file does not contain substantial content information. Therefore, fast uploading as well as speed measurement can be achieved.

After the client establishes the speed measurement connection with the service terminal, the network state parameters of the primary link can be acquired one time; after the speed measurement file is uploaded, the network state parameters of the link can be acquired one more time, so that the network state parameters before and after sending the bandwidth test file are respectively acquired. The network state parameters may be acquired, for example, through a socket port and an associated protocol(s). The network state parameters include a packet loss rate, a round-trip time (RTT) of a packet from a client to a server, and the like that can reflect the state of the network. A confidence of the network status parameters acquired for the first time is not high and can be used as a reference for the network status when a value fluctuates considerably.

S120, determining a first network bandwidth and a second network bandwidth based on the network state parameters and the volume of the bandwidth test file.

The first network bandwidth refers to a network bandwidth value determined by conventional network speed measurement. That is, the first network bandwidth is determined based on the volume of the bandwidth test file and a round trip latency of data transmission in the network state parameters. For example, the volume of the bandwidth test file may be divided by a duration consumed for uploading the bandwidth test file to obtain the corresponding first network bandwidth value, wherein the duration consumed for uploading the bandwidth test file is determined based on data in the network state parameters.

The second network bandwidth is obtained by inputting the network state parameters into a preset offline bandwidth prediction model. The preset offline bandwidth prediction model may be a bandwidth estimation model such as a mathematics-based modeling formula (The Mathis et.al. Formula) or a delay bandwidth product formula.

In the present embodiment, in view of the data amount of the uploaded bandwidth test file is small, which is limited by the transmission protocol, there may be errors in some of the collected network state parameters, and the first network bandwidth result may have certain errors with the real bandwidth; the accuracy of the second network bandwidth also remains to be improved since there may be errors in the network state parameters, which may also cause corresponding errors in the predicted bandwidth based on the preset offline bandwidth prediction model. Therefore, instead of using the first network bandwidth and the second network bandwidth directly as the final network bandwidth estimation result, the final network bandwidth estimation result is determined through step S130.

S130, inputting the network state parameters, the first network bandwidth, and the second network bandwidth into a current latest network bandwidth estimation model to obtain a target network bandwidth estimation result.

The network bandwidth estimation model is a machine learning model, which is generated by learning collected network state parameters, a network bandwidth value (the first network bandwidth) determined by conventional calculation based on a volume of a bandwidth test file and a duration consumed for uploading the bandwidth test file, a network bandwidth estimation result (the second network bandwidth) determined based on a preset offline bandwidth prediction model, and a corresponding actual network bandwidth in all previous network bandwidth estimation processes. The network bandwidth estimation model may be pre-configured in the client.

The network bandwidth estimation model may be a neural network model or a weight parameter model. The weight parameter model refers to that the machine-learned network bandwidth estimation model is an optimized function in which weight values of a plurality of input data are included, and the target network bandwidth estimation result can be finally calculated based on the corresponding weight values.

In the present embodiment, after the analysis and calculation of the network bandwidth estimation model, an optimized target network bandwidth estimation result can be finally obtained, and the accuracy is improved compared with the first network bandwidth and the second network bandwidth.

According to the technical scheme of the embodiments of the present disclosure, a bandwidth test file with a small volume can be sent to a service terminal, and network state parameters before and after sending the bandwidth test file can be acquired respectively; a first network bandwidth and a second network bandwidth are determined based on the network state parameters and a volume of the bandwidth test file; the network state parameters, the first network bandwidth and the second network bandwidth are input into a current latest network bandwidth estimation model to obtain a target network bandwidth estimation result, and a target network bandwidth estimation result is finally output, that is, the network state parameters and the determined network bandwidth values by calculation in different ways are comprehensively analyzed by the pre-trained network bandwidth estimation model, and a target network bandwidth estimation result is finally output. The technical scheme of the embodiments of the present disclosure solves the problem that the network speed measurement result is inaccurate due to the adopting a small file, the accuracy of the network speed measurement result is improved, a better video coding strategy is better matched for the video to be uploaded, and the user experience of video uploading is improved.

### Embodiment 2

The present embodiment of the present disclosure may be combined with a plurality of alternatives in the network bandwidth estimation method applied to a client provided in the above embodiments. The network bandwidth estimation method applied to a client according to the present embodiment describes a process of selecting a more appropriate network bandwidth estimation model according to the network state parameters and performing network bandwidth estimation.

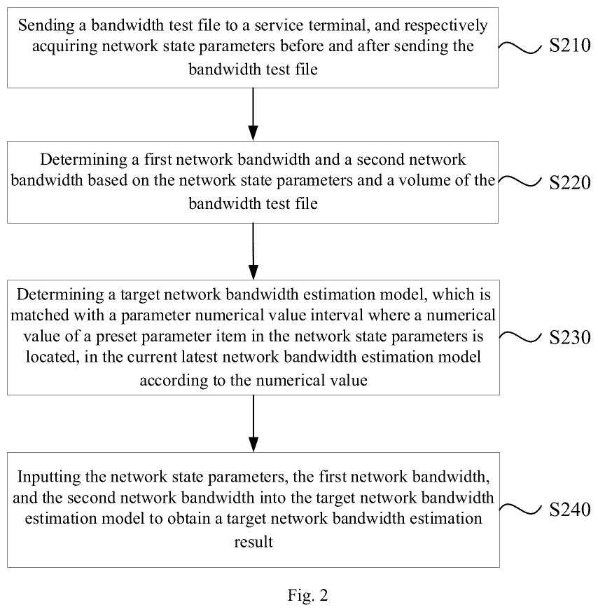

FIG. 2 is a flowchart illustrating a network bandwidth estimation method applied to a client according to Embodiment 2 of the present disclosure. As shown in FIG. 2, the present embodiment provides a network bandwidth estimation method applied to a client, comprising the following steps.

S210, sending a bandwidth test file to a service terminal, and respectively acquiring network state parameters before and after sending the bandwidth test file.

S220, determining a first network bandwidth and a second network bandwidth based on the network state parameters and a volume of the bandwidth test file.

S230, determining a target network bandwidth estimation model, which is matched with a parameter numerical value interval where a numerical value of a preset parameter item in the network state parameters is located, in the current latest network bandwidth estimation model according to the numerical value.

In the present embodiment, the current latest network bandwidth estimation model comprises a group of models, each model in the group of models being matched with a parameter numerical value interval where the value of the network state parameter is located. For example, in the process of model training, in order to improve the accuracy of the output result of the model, model training samples are grouped according to the numerical values of the network state parameters in the model training samples, to obtain a plurality of model training sample groups. For example, the model training samples are grouped into three groups according to the value of RTT, wherein network state parameters with RTT values less than 50 milliseconds are in one group, network state parameters with RTT values between 50 milliseconds and 200 milliseconds are in one group, and network state parameters with RTT values greater than 200 milliseconds are in one group. The model is trained on the basis of the samples of each model training sample group, respectively, to obtain in a plurality of network bandwidth estimation models finally. Each network bandwidth estimation model has a better adaptability to the network bandwidth test data of the numerical value interval of its corresponding preset parameter item, and can get better results.

S240, inputting the network state parameters, the first network bandwidth, and the second network bandwidth into the target network bandwidth estimation model to obtain a target network bandwidth estimation result.

After the target network bandwidth estimation model which matches the collected network status parameters and the calculated first network bandwidth and second network bandwidth is determined, the target network bandwidth estimation result is obtained by directly inputting the network status parameters, the first network bandwidth and the second network bandwidth into the target network bandwidth estimation model.

Since the target network bandwidth estimation model is a network bandwidth estimation model that is matched after being refined according to the values of the network state parameters, the accuracy of the output result of the model can be improved to some extent, thereby making the accuracy of the network bandwidth prediction result higher.

The technical solution of an embodiment of the present disclosure, by sending a bandwidth test file to a service terminal, and respectively acquiring network state parameters before and after sending the bandwidth test file; determining a first network bandwidth and a second network bandwidth based on the network state parameters and the volume of the bandwidth test file; and matching the target network bandwidth estimation model with the group of network state parameters according to numerical values of the network state parameters, inputting the network state parameters, the first network bandwidth and the second network bandwidth into the current latest network bandwidth estimation model to obtain the target network bandwidth estimation result, i.e., by previously trained the network bandwidth estimation model, analyzing the network state parameters in combination and calculating the network bandwidth values determined in different ways, finally outputting a target network bandwidth estimation result. The technical solution of the embodiments of the present disclosure solves the problem that adopting a small file causes the network speed measurement result to be inaccurate, achieves improving the accuracy of the network speed measurement result to better match the better video coding strategy for the to-be-uploaded video, and improves the user video upload experience sense.

### Embodiment 3

The embodiments of the present disclosure may be combined with a plurality of alternatives in the network bandwidth estimation method applied to a client provided in the above embodiments. The network bandwidth estimation method applied to the client according to the present embodiment describes a process of dynamically acquiring the latest network bandwidth estimation model from the service terminal and performing network bandwidth estimation.

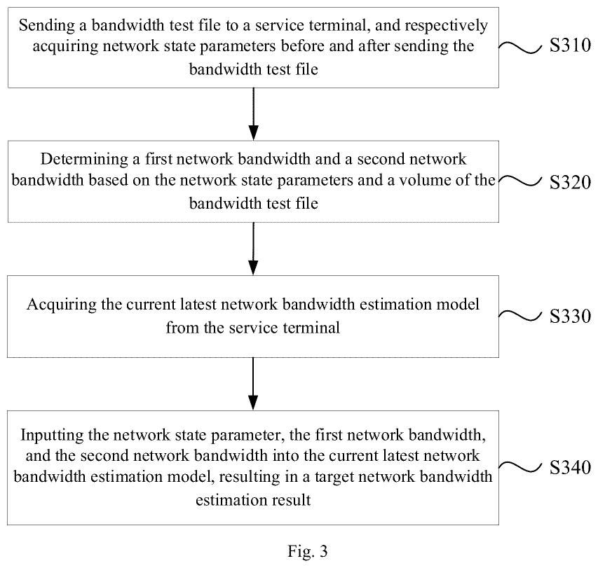

FIG. 3 is a flowchart illustrating a network bandwidth estimation method applied to a client according to an embodiment 3 of the present disclosure.

As shown in FIG. 3, the present embodiment provides a network bandwidth estimation method applied to a client, comprising the following steps.

S310, sending a bandwidth test file to a service terminal, and respectively acquiring network state parameters before and after sending the bandwidth test file.

S320, determining a first network bandwidth and a second network bandwidth based on the network state parameters and a volume of the bandwidth test file.

S330, acquiring the current latest network bandwidth estimation model from the service terminal.

In this embodiment, the network bandwidth estimation model is not pre-configured at the client, and is acquired from the service terminal during the process of network bandwidth estimation.

The execution order of the step S330 is not strictly limited to that after step S320, and the step S330 may be executed before or after the execution of the step S310 or the step S320 to obtain the network bandwidth estimation model. That is, as long as the current latest network bandwidth estimation model is obtained before the network bandwidth estimation model is used in step S340.

The acquisition of the network bandwidth estimation model from the service terminal is because the model is continually iteratively updated at the service terminal as new model training samples are generated. The updating of the network bandwidth estimation model is more efficient and more friendly to the memory configuration of the client compared to pre-configuration at the client.

In addition, an expiration time may be set for the acquired network bandwidth estimation model, and if the time interval between the next estimated network bandwidth and the current estimated network bandwidth is within the expiration time, the network bandwidth estimation model may not be acquired again to the service terminal.

S340, inputting the network state parameter, the first network bandwidth, and the second network bandwidth into the current latest network bandwidth estimation model, resulting in a target network bandwidth estimation result.

In an alternative implementation, in each process of network bandwidth estimation, the network state parameters acquired and the first network bandwidth and the second network bandwidth calculated by the client, and the actual network bandwidth corresponding to the target network bandwidth estimation result may be transmitted to the service terminal through the data transmission interface set in advance, so that the service terminal performs training and updating of the network bandwidth estimation model according to the received data.

The technical solution of the embodiments of the present disclosure, by sending a bandwidth test file with small volume to a service terminal, and respectively acquiring network state parameters before and after sending the bandwidth test file; determining a first network bandwidth and a second network bandwidth based on the network state parameters and a volume of the bandwidth test file; and acquiring the current latest network bandwidth estimation model from the service terminal, inputting the network state parameter, the first network bandwidth, and the second network bandwidth into the current latest network bandwidth estimation model, resulting in a target network bandwidth estimation result. That is, by previously trained the network bandwidth estimation model, analyzing the network state parameters in combination and calculating the network bandwidth values determined in different ways, finally outputting a target network bandwidth estimation result. The technical solution of the embodiments of the present disclosure solves the problem that adopting a small file causes the network speed measurement result to be inaccurate, achieves improving the accuracy of the network speed measurement result to better match the better video coding strategy for the to-be-uploaded video, and improves the user video upload experience sense.

### Embodiment 4

An embodiment of the present disclosure is based on an optional implementation of a plurality of alternatives in the network bandwidth estimation method applied to a client provided in the above embodiments, which may be combined with the plurality of alternatives. The method for estimating network bandwidth applied to a client according to the present embodiment describes the timing of performing network bandwidth test and the process of performing network bandwidth estimation.

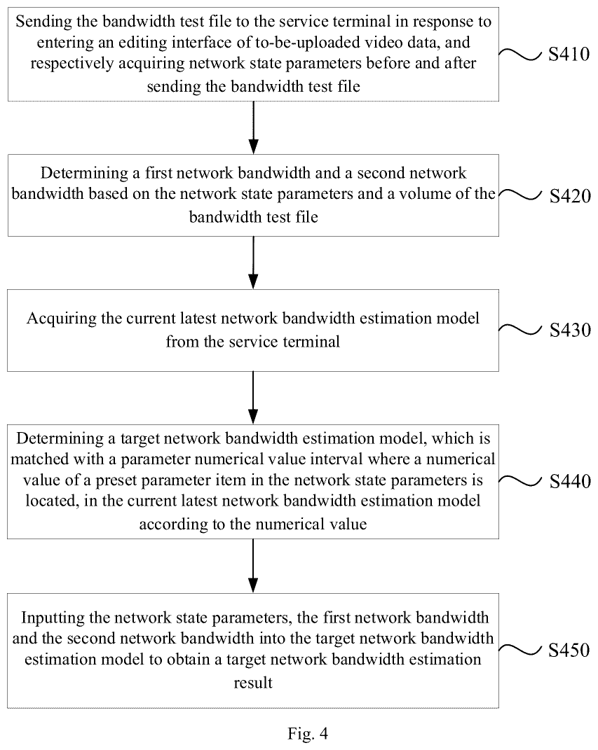

FIG. 4 is a flowchart illustrating a network bandwidth estimation method applied to a client according to Embodiment 4 of the present disclosure.

As shown in FIG. 4, the present embodiment provides a network bandwidth estimation method applied to a client, including the following steps.

S410, sending the bandwidth test file to the service terminal in response to entering an editing interface of to-be-uploaded video data, and respectively acquiring network state parameters before and after sending the bandwidth test file.

In the present embodiment, when the user performs editing of the video data to be uploaded, the bandwidth test file is sent to the service terminal in advance to start network bandwidth estimation. While no longer waiting for the user to trigger the upload operation of the to-be-uploaded video. Then, until the user triggers the operation of the video uploading, the coding strategy of the video to be uploaded can be determined based on the result of the network bandwidth estimation, so that the duration of the entire video uploading process can be reduced, so that the video upload process can be optimized, and thus the user experience can be improved.

In response to entering the editing interface for the video data to be uploaded, an speed measurement connection can be established between the client and the service terminal, and the network status parameters of the link can be obtained once. After the speed measurement file is uploaded, the network state parameters of the link may be acquired one more time, so that the network state parameters before and after the bandwidth test file is transmitted are respectively acquired.

S420, determining a first network bandwidth and a second network bandwidth based on the network state parameters and a volume of the bandwidth test file.

The first network bandwidth refers to a network bandwidth numerical value determined by a conventional network speed measurement, i.e., the first network bandwidth is determined according to the volume of the bandwidth test file and the round-trip latency of data transmission among the network state parameters. For example, the volume of the bandwidth test file may be divided by the length of duration taken to upload the bandwidth test file to obtain the corresponding first network bandwidth value.

The second network bandwidth is obtained by inputting the network state parameter into a preset offline bandwidth prediction model, resulting in the second network bandwidth. The preset offline bandwidth prediction model may be a bandwidth estimation model such as a mathematical-based modeling formula or a delay bandwidth product formula.

S430, acquiring the current latest network bandwidth estimation model from the service terminal.

The network bandwidth estimation model is not pre-configured at the client and is obtained from the service terminal during the network bandwidth estimation process. The model is constantly iteratively updated at the service terminal.

S440, determining a target network bandwidth estimation model, which is matched with a parameter numerical value interval where a numerical value of a preset parameter item in the network state parameters is located, in the current latest network bandwidth estimation model according to the numerical value.

The current latest network bandwidth estimation model comprises a set of models, each model in the set of models being matched to a parameter numerical value interval in which the numerical value of the network state parameter lies. That is, in the network bandwidth estimation process, the target network bandwidth estimation model is selected to be a refined model, which is more capable of obtaining a more accurate network bandwidth estimation result.

S450, inputting the network state parameters, the first network bandwidth and the second network bandwidth into the target network bandwidth estimation model to obtain a target network bandwidth estimation result.

The network bandwidth estimation model is a model for machine learning determination based on the network state parameter, the first network bandwidth, the second network bandwidth, and the corresponding actual network bandwidth in the historical network bandwidth estimation process, for example, the model may be a neural network model or a weight parameter model. The target network bandwidth estimation result is obtained by inputting the network state parameters, the first network bandwidth and the second network bandwidth into a target network bandwidth estimation model.

In addition, n each process of network bandwidth estimation, the network state parameters acquired and the first network bandwidth and the second network bandwidth calculated by the client, and the actual network bandwidth corresponding to the target network bandwidth estimation result may be transmitted to the service terminal through the data transmission interface set in advance, so that the service terminal performs training and updating of the network bandwidth estimation model according to the received data.

The technical solution of an embodiment of the present disclosure, by advancing the timing of making network bandwidth estimation, when a user edits a video to be uploaded, turns on a flow of network bandwidth estimation, sends a bandwidth test file with small volume to a service terminal, and obtains network state parameters before and after sending the bandwidth test file, respectively; determining a first network bandwidth and a second network bandwidth based on the network state parameters and a volume of the bandwidth test file; and obtaining a current latest network bandwidth estimation model from the service terminal, inputting the network state parameter, the first network bandwidth and the second network bandwidth into the latest network bandwidth estimation model matched with the parameter interval in which the network state parameter values are located, and obtaining a target network bandwidth estimation result, i.e., by previously training the network bandwidth estimation model, analyzing the network state parameter in combination and calculating the network bandwidth values determined differently, and finally outputting a target network bandwidth estimation result. The technical solution of the embodiments of the present disclosure solves the problem that adopting a small file causes the network speed measurement result to be inaccurate, achieves improving the accuracy of the network speed measurement result to better match the better video coding strategy for the to-be-uploaded video, and improves the user video upload experience sense.

### Embodiment 5

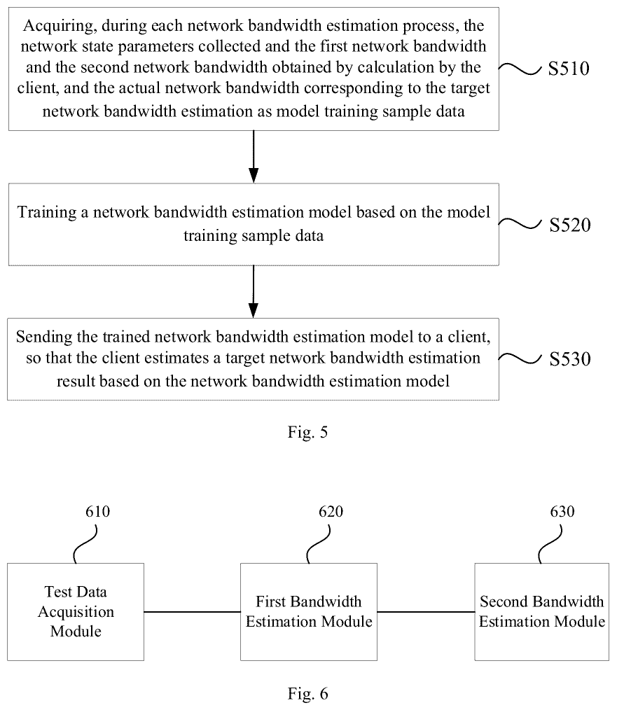

FIG. 5 is a flowchart diagram of a network bandwidth estimation method applied to a service terminal provided by Embodiment 5 of the present disclosure, which is suitable for a scenario of rapidly testing a network bandwidth, training a network bandwidth estimation model, particularly in a case of performing a bandwidth prediction before a user uploads a video to determine a video dynamic coding strategy. The method may be performed by a network bandwidth estimation apparatus arranged at the service terminal, which may be implemented in software and/or hardware, which may be arranged in an electronic device, such as a mobile terminal or a server device.

As shown in FIG. 5, the method for estimating network bandwidth applied to a service terminal according to the present embodiment includes the following steps.

S510, acquiring, during each network bandwidth estimation process, the network state parameters collected and the first network bandwidth and the second network bandwidth obtained by calculation by the client, and the actual network bandwidth corresponding to the target network bandwidth estimation as model training sample data.

In the process of network bandwidth estimation by the client, the collected network state parameters, the intermediate bandwidth estimation values calculated in the bandwidth estimation process, and the actual network bandwidth values corresponding to the final network bandwidth estimation result are uploaded to the service terminal as training samples for the network bandwidth estimation model by the service terminal.

The network state parameters are the network state parameters of the network speed measurement link respectively acquired by the client before and after sending the speed measurement file upload to the service terminal. The network state parameters may include a packet loss rate, a round-trip time (RTT) between a bandwidth test file from a client to a server, and other parameters that can reflect the network state. The first network bandwidth is the network bandwidth value determined by the client according to the conventional network speed measurement manner, i.e., the first network bandwidth is determined according to the volume of the bandwidth test file and the round trip delay of data transmission in the network state parameters, and for example, the volume of the bandwidth test file divided by the RTT and multiplied by two can be used to obtain the corresponding first network bandwidth value. The second network bandwidth is obtained by the client inputs the network state parameters into the preset offline bandwidth prediction model, resulting in the second network bandwidth. The preset offline bandwidth prediction model may be a bandwidth estimation model such as a mathematically based modeling formula or a delayed bandwidth product formula.

S520, training a network bandwidth estimation model based on the model training sample data.

In this embodiment, the network bandwidth estimation model is trained by means of machine learning. During the training process, a suitable model can be selected for the problem to be solved by the model training. The model is equivalent to a set of functions. The model itself may have different structures, for example, a linear fit model, a non-linear fit model, a neural network model, and the like. A Loss Function was set to measure how well the model was. Based on multiple rounds of model training on model training sample data, the “best” function can be found, i.e., the final network bandwidth estimation model can be obtained.

In an optional implementation, in conducting model training, multiple model training sample data are grouped according to numerical values of preset parameter terms in the network state parameters; And separately performing model training based on the grouped model training sample parameters to obtain a plurality of network bandwidth estimation models. A better fit of each network bandwidth estimation model to the corresponding network bandwidth test data of the value range of the preset parameter term results.

S530, sending the trained network bandwidth estimation model to a client, so that the client estimates a target network bandwidth estimation result based on the network bandwidth estimation model.

According to an embodiment of the present disclosure, by using the network state parameter obtained from the client, the first network bandwidth and the second network bandwidth calculated by the client, and the actual network bandwidth corresponding to the target network bandwidth estimation result as model training sample data, the target network bandwidth estimation model is trained, and the network state parameter is analyzed comprehensively and the determined network bandwidth value is calculated differently, and one target network bandwidth estimation result is finally output. And sending the trained model to the client for network bandwidth estimation. The technical solution of the embodiments of the present disclosure solves the problem that adopting a small file causes the network speed measurement result to be inaccurate, achieves improving the accuracy of the network speed measurement result to better match the better video coding strategy for the to-be-uploaded video, and improves the user video upload experience sense.

### Embodiment 6

FIG. 6 is a block diagram illustrating a network bandwidth estimation apparatus configured in a client according to Embodiment 6 of the present disclosure. The present embodiment provides a client-configured network bandwidth estimation apparatus suitable for use in scenarios where network bandwidth is rapidly tested, particularly where bandwidth prediction is performed before a user uploads a video to determine a video dynamic coding strategy.

As shown in FIG. 6, a network bandwidth estimation apparatus configured in a client includes a test data acquisition module 610, a first bandwidth estimation module 620, and a second bandwidth estimation module 630.

The test data acquisition module 610 is configured to send a bandwidth test file to a service terminal, and acquire network state parameters before and after sending the bandwidth test file respectively, wherein a volume of the bandwidth test file is less than a preset file volume threshold. The first bandwidth estimation module 620 is configured to to determine a first network bandwidth and a second network bandwidth based on the network state parameters and the volume of the bandwidth test file; The second bandwidth estimation module 630 is configured to input the network state parameters, the first network bandwidth, and the second network bandwidth into a current latest network bandwidth estimation model to obtain a target network bandwidth estimation result. The current latest network bandwidth estimation model is a model determined based on machine learning of the network state parameters, the first network bandwidth, the second network bandwidth, and an actual network bandwidth corresponding to the target network bandwidth estimation result in historical network bandwidth estimation processes.

According to the technical scheme of the embodiments of the present disclosure, a bandwidth test file with a small volume can be sent to a service terminal, and network state parameters before and after sending the bandwidth test file can be acquired respectively; a first network bandwidth and a second network bandwidth are determined based on the network state parameters and a volume of the bandwidth test file; the network state parameters, the first network bandwidth and the second network bandwidth are input into a current latest network bandwidth estimation model to obtain a target network bandwidth estimation result, and a target network bandwidth estimation result is finally output, that is, the network state parameters and the determined network bandwidth values by calculation in different ways are comprehensively analyzed by the pre-trained network bandwidth estimation model, and a target network bandwidth estimation result is finally output. The technical scheme of the embodiments of the present disclosure solves the problem that the network speed measurement result is inaccurate due to the adopting a small file, the accuracy of the network speed measurement result is improved, a better video coding strategy is better matched for the video to be uploaded, and the user experience of video uploading is improved.

In some optional implementations, the second bandwidth estimation module 630 is configured to:
determine a target network bandwidth estimation model, which is matched with a parameter numerical value interval where a numerical value of a preset parameter item in the network state parameters is located, in the current latest network bandwidth estimation model according to the numerical value; and
input the network state parameters, the first network bandwidth and the second network bandwidth into the target network bandwidth estimation model to obtain the target network bandwidth estimation result.

In some optional implementations, the first bandwidth estimation module 620 includes a first bandwidth estimation sub-module and a second bandwidth estimation sub-module;

The first bandwidth estimation sub-module is configured to determine the first network bandwidth according to the volume of the bandwidth test file and a data transmission round trip latency in the network state parameters;

The second bandwidth estimation sub-module configured to the network state parameters into a preset offline bandwidth prediction model, to obtain the second network bandwidth.

In some optional implementations, the test data acquisition module 610 is configured to send the bandwidth test file to the service terminal in case of entering an editing interface of to-be-uploaded video data.

In some optional implementations, the network bandwidth estimation apparatus further includes:
a bandwidth estimation model acquiring module configured to acquire the current latest network bandwidth estimation model from the service terminal after the bandwidth test file to the service terminal.

In some optional implementations, the network bandwidth estimation apparatus further includes:
a parameter uploading interface module configured to send the acquired network state parameters, the first network bandwidth and the second network bandwidth obtained by calculation, and an actual network bandwidth corresponding to the target network bandwidth estimation result to the service terminal in each network bandwidth estimation process, so that the service terminal performs training and updating of the network bandwidth estimation model according to the received data.

In some optional implementations, the network bandwidth estimation model includes a neural network model and a weight parameter model.

The apparatus for estimating network bandwidth configured at a client according to the embodiments of the present disclosure may perform the method for estimating network bandwidth applied to the client according to any of the embodiments of the present disclosure, and may have functional modules and effects corresponding to the method.

A plurality of units and modules included in the above apparatus are divided only according to functional logic, but are not limited to the above division as long as corresponding functions can be realized; In addition, the names of the plurality of functional units are also merely for convenience of distinguishing from each other, and are not used to limit the protection scope of the embodiments of the present disclosure.

### Example 7

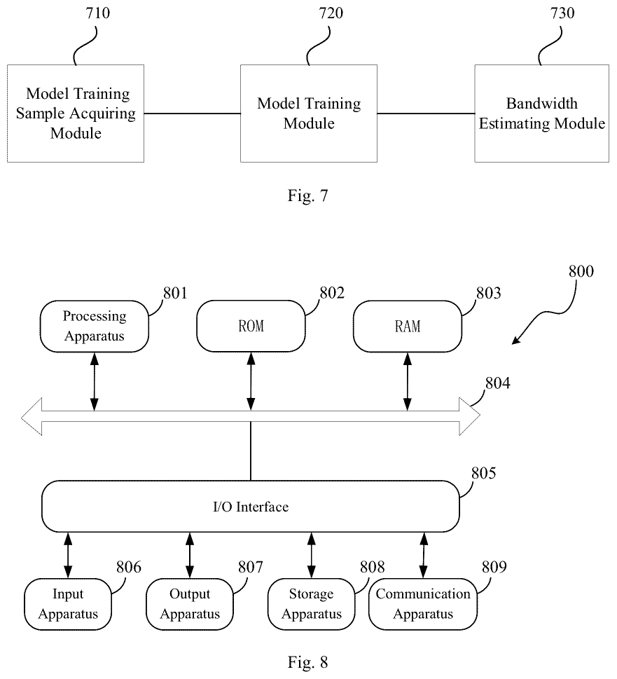

FIG. 7 is a block diagram of a network bandwidth estimating apparatus configured at a service terminal according to Embodiment 7 of the present disclosure. The network bandwidth estimation apparatus provided at the service terminal according to the present embodiment describes a process of performing training of a network bandwidth estimation model at the service terminal.

As shown in FIG. 7, the network bandwidth estimating apparatus configured at the service terminal includes a model training sample obtaining module 710, a model training module 720, and a bandwidth estimating module 730.

The model training sample acquiring module 710 configured to oacquire network state parameters collected, a first network bandwidth and a second network bandwidth obtained by calculation, and an actual network bandwidth corresponding to a target network bandwidth estimation result, in each network bandwidth estimation process by a client, as model training sample data. The model training module 720 configured to train a network bandwidth estimation model based on the model training sample data. The bandwidth estimation module 730 configured to send the trained network bandwidth estimation model to the client, so that the client estimates a target network bandwidth estimation result based on the network bandwidth estimation model.

According to an embodiment of the present disclosure, by using the network state parameter obtained from the client, the first network bandwidth and the second network bandwidth calculated by the client, and the actual network bandwidth corresponding to the target network bandwidth estimation result as model training sample data, the target network bandwidth estimation model is trained, and the network state parameter is analyzed comprehensively and the determined network bandwidth value is calculated differently, and one target network bandwidth estimation result is finally output; and sending the trained model to the client for network bandwidth estimation. The technical solution of the embodiments of the present disclosure solves the problem that adopting a small file causes the network speed measurement result to be inaccurate, achieves improving the accuracy of the network speed measurement result to better match the better video coding strategy for the to-be-uploaded video, and improves the experience sense of the user's video upload.

In some optional implementations, the model training module 720 is configured to:
group multiple model training sample data according to numerical values of preset parameter items in the network state parameters; and
separately perform model training based on the grouped model training sample parameters to obtain a plurality of network bandwidth estimation models.

The device for estimating network bandwidth configured at a service terminal according to the embodiment of the present disclosure may perform the method for estimating network bandwidth applied to a service terminal according to any of the embodiments of the present disclosure, and may have functional modules and effects corresponding to the method.

A plurality of units and modules included in the above apparatus are divided only according to functional logic, but are not limited to the above division as long as corresponding functions can be realized; In addition, the names of the plurality of functional units are also merely for convenience of distinguishing from each other, and are not used to limit the protection scope of the embodiments of the present disclosure.

### Example 8

Referring to FIG. 8, FIG. 8 illustrates a schematic structural diagram of an electronic device 800 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 8 is merely an example, and should not pose any limitation to the functions and the range of use of the embodiments of the present disclosure.

As illustrated in FIG. 8, the electronic device 800 may include a processing apparatus 801 (e.g., a central processing unit, a graphics processing unit, etc.), which can perform various suitable actions and processing according to a program stored in a read-only memory (ROM) 802 or a program loaded from a storage apparatus 808 into a random-access memory (RAM) 803. The RAM 803 further stores various programs and data required for operations of the electronic device 800. The processing apparatus 801, the ROM 802, and the RAM 803 are interconnected by means of a bus 804. An input/output (I/O) interface 805 is also connected to the bus 804.

Usually, the following apparatus may be connected to the I/O interface 805: an input apparatus 806 including, for example, a touch screen, a touch pad, a keyboard, a mouse, a camera, a microphone, an accelerometer, a gyroscope, or the like; an output apparatus 807 including, for example, a liquid crystal display (LCD), a loudspeaker, a vibrator, or the like; a storage apparatus 808 including, for example, a magnetic tape, a hard disk, or the like; and a communication apparatus 809. The communication apparatus 809 may allow the electronic device 800 to be in wireless or wired communication with other devices to exchange data. While FIG. 5 illustrates the electronic device 800 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 809 and installed, or may be installed from the storage apparatus 808, or may be installed from the ROM 802. When the computer program is executed by the processing apparatus 801, the above-mentioned functions defined in the methods of some embodiments of the present disclosure are performed.

The electronic device provided by the embodiment of the present disclosure belongs to the same concept as the network bandwidth estimation method applied to a client or a service terminal provided by the above embodiment, technical details that are not elaborately described in the present embodiment may be referred to the above embodiment, and the present embodiment has the same effect as the above embodiment.

### Example 9

An embodiment of the present disclosure provides a computer storage medium having stored thereon a computer program which, when executed by a processor, implements the network bandwidth estimation method applied to a client or a service terminal provided by the above embodiment.

The above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to:
send a bandwidth test file to a service terminal, and respectively acquiring network state parameters before and after sending the bandwidth test file, wherein a volume of the bandwidth test file is less than a preset file volume threshold;
determine a first network bandwidth and a second network bandwidth based on the network state parameters and the volume of the bandwidth test file;
input the network state parameters, the first network bandwidth, and the second network bandwidth into a current latest network bandwidth estimation model to obtain a target network bandwidth estimation result;
the current latest network bandwidth estimation model is a model determined based on machine learning of the network state parameters, the first network bandwidth, the second network bandwidth, and an actual network bandwidth corresponding to the target network bandwidth estimation result in all previous network bandwidth estimation processes.

Alternatively, the computer-readable medium carries one or more programs that, when executed by the electronic device, cause the electronic device to:
acquire network state parameters collected, a first network bandwidth and a second network bandwidth obtained by calculation, and an actual network bandwidth corresponding to a target network bandwidth estimation result, in each network bandwidth estimation process by a client, as model training sample data;
train a network bandwidth estimation model based on the model training sample data;
send the trained network bandwidth estimation model to the client, so that the client estimates a target network bandwidth estimation result based on the network bandwidth estimation model.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

[Example 1] According to one or more embodiments of the present disclosure, there is provided a network bandwidth estimation method applied to a client, the method including:
sending a bandwidth test file to a service terminal, and respectively acquiring net work state parameters before and after sending the bandwidth test file, wherein a volume of the bandwidth test file is less than a preset file volume threshold;
determining a first network bandwidth and a second network bandwidth based on the network state parameters and the volume of the bandwidth test file;
inputting the network state parameters, the first network bandwidth, and the second network bandwidth into a current latest network bandwidth estimation model to obtain a target network bandwidth estimation result;
wherein the current latest network bandwidth estimation model is a model determined based on machine learning of the network state parameters, the first network bandwidth, the second network bandwidth, and an actual network bandwidth corresponding to the target network bandwidth estimation result in all previous network bandwidth estimation processes.

[Example 2] According to one or more embodiments of the present disclosure, there is provided a network bandwidth estimation method applied to a client, further including:
in some optional implementations, inputting the network state parameters, the first network bandwidth, and the second network bandwidth into the current latest network bandwidth model to obtain the target network bandwidth estimation result includes:
determining a target network bandwidth estimation model, which is matched with a parameter numerical value interval where a numerical value of a preset parameter item in the network state parameters is located, in the current latest network bandwidth estimation model according to the numerical value;
inputting the network state parameters, the first network bandwidth and the second network bandwidth into the target network bandwidth estimation model to obtain the target network bandwidth estimation result.

[Example 3] According to one or more embodiments of the present disclosure, there is provided a network bandwidth estimation method applied to a client, including:
in some optional implementations, determining the first network bandwidth and the second network bandwidth based on the network state parameters and the volume of the bandwidth test file includes:
determining the first network bandwidth according to the volume of the bandwidth test file and a data transmission round trip latency in the network state parameters;
inputting the network state parameters into a preset offline bandwidth prediction model, to obtain the second network bandwidth.

[Example 4] According to one or more embodiments of the present disclosure, pro vides a network bandwidth estimation method applied to a client, further including:
in some optional implementations, sending the bandwidth test file to the service terminal includes:
sending the bandwidth test file to the service terminal in case of entering an editing interface of to-be-uploaded video data.

[Example 5] According to one or more embodiments of the present disclosure, there is provided a network bandwidth estimation method applied to a client, further including:
in some optional implementations, after sending the bandwidth test file to the service terminal, the method further includes:
acquiring the current latest network bandwidth estimation model from the service terminal.

[Example 6] According to one or more embodiments of the present disclosure, there is provided a network bandwidth estimation method applied to a client, further including:
in some optional implementations, sending the acquired network state parameters, the first network bandwidth and the second network bandwidth obtained by calculation, and an actual network bandwidth corresponding to the target network bandwidth estimation result to the service terminal in each network bandwidth estimation process, so that the service terminal performs training and updating of the network bandwidth estimation model according to the received data.

[Example 7] According to one or more embodiments of the present disclosure, there is provided a network bandwidth estimation method applied to a client, further including:
in some optional implementations, the network bandwidth estimation model includes a neural network model and a weight parameter model.

[Example 8] According to one or more embodiments of the present disclosure, provides a network bandwidth estimation method applied to a service terminal, the method including:
acquiring network state parameters collected, a first network bandwidth and a second network bandwidth obtained by calculation, and an actual network bandwidth corresponding to a target network bandwidth estimation result, in each network bandwidth estimation process by a client, as model training sample data;
training a network bandwidth estimation model based on the model training sample data;
sending the trained network bandwidth estimation model to the client, so that the client estimates a target network bandwidth estimation result based on the network bandwidth estimation model.

[Example 9] According to one or more embodiments of the disclosure, there is provided a network bandwidth estimation method applied to a service terminal, further including:
in some optional implementations, the training the network bandwidth estimation model based on the data includes:
grouping a plurality of model training sample data according to a numerical value of a preset parameter item in the network state parameters;
performing model training respectively based on the grouped model training sample parameters to obtain a plurality of network bandwidth estimation models.

[Example 10] According to one or more embodiments of the disclosure, provides a network bandwidth estimation apparatus configured at a client, including:
a test data acquisition module, configured to send a bandwidth test file to a service terminal, and respectively acquire network state parameters before and after sending the bandwidth test file, wherein a volume of the bandwidth test file is less than a preset file volume threshold;
a first bandwidth estimation module, configured to determine a first network bandwidth and a second network bandwidth based on the network state parameters and the volume of the bandwidth test file;
a second bandwidth estimation module, configured to input the network state parameters, the first network bandwidth, and the second network bandwidth into a current latest network bandwidth estimation model to obtain a target network bandwidth estimation result;
wherein the current latest network bandwidth estimation model is a model determined based on machine learning of the network state parameters, the first network bandwidth, the second network bandwidth, and an actual network bandwidth corresponding to the target network bandwidth estimation result in historical network bandwidth estimation processes.

[Example 11] According to one or more embodiments of the disclosure, there is provided a network bandwidth estimation apparatus configured in a client, further including:
in some optional implementations, the second bandwidth estimation module is configured to:
determine a target network bandwidth estimation model, which is matched with a parameter numerical value interval where a numerical value of a preset parameter item in the network state parameters is located, in the current latest network bandwidth estimation model according to the numerical value; and
input the network state parameters, the first network bandwidth and the second network bandwidth into the target network bandwidth estimation model to obtain the target network bandwidth estimation result.

[Example 12] According to one or more embodiments of the disclosure, there is provided a network bandwidth estimation apparatus configured at a client, further including:
in some optional implementations, the first bandwidth estimation module includes a first bandwidth estimation sub-module and a second bandwidth estimation sub-module;

The first bandwidth estimation sub-module is configured to determine the first network bandwidth according to the volume of the bandwidth test file and a data transmission round trip latency in the network state parameters;

The second bandwidth estimation sub-module configured to the network state parameters into a preset offline bandwidth prediction model, to obtain the second network bandwidth.

[Example 13] According to one or more embodiments of the disclosure, there is provided a network bandwidth estimation apparatus configured at a client, further including:
in some optional implementations, the test data acquisition module may be further configured to send the bandwidth test file to the service terminal in case of entering an editing interface of to-be-uploaded video data.

[Example 14] According to one or more embodiments of the disclosure, there is provided a network bandwidth estimation apparatus configured at a client, further including:
in some optional implementations, the network bandwidth estimation apparatus further includes:
a bandwidth estimation model acquiring module configured to acquire the current latest network bandwidth estimation model from the service terminal after the bandwidth test file to the service terminal.

[Example 15] According to one or more embodiments of the disclosure, there is provided a network bandwidth estimation apparatus configured in a client, further including:
in some optional implementations, the network bandwidth estimation apparatus further includes:
a parameter uploading interface module configured to send the acquired network state parameters, the first network bandwidth and the second network bandwidth obtained by calculation, and an actual network bandwidth corresponding to the target network bandwidth estimation result to the service terminal in each network bandwidth estimation process, so that the service terminal performs training and updating of the network bandwidth estimation model according to the received data.

[Example 16] According to one or more embodiments of the disclosure, there is provided a network bandwidth estimation apparatus configured at a client, further including:
in some optional implementations, the network bandwidth estimation model includes a neural network model and a weight parameter model.

[Example 17] According to one or more embodiments of the disclosure, there is provided a network bandwidth estimation apparatus configured at a service terminal, including:
a test data acquisition module, configured to send a bandwidth test file to a service terminal, and respectively acquire network state parameters before and after sending the bandwidth test file, wherein a volume of the bandwidth test file is less than a preset file volume threshold;
a first bandwidth estimation module, configured to determine a first network bandwidth and a second network bandwidth based on the network state parameters and the volume of the bandwidth test file;
a second bandwidth estimation module, configured to input the network state parameters, the first network bandwidth, and the second network bandwidth into a current latest network bandwidth estimation model to obtain a target network bandwidth estimation result;
wherein the current latest network bandwidth estimation model is a model determined based on machine learning of the network state parameters, the first network bandwidth, the second network bandwidth, and an actual network bandwidth corresponding to the target network bandwidth estimation result in historical network bandwidth estimation processes.

[Example 18] According to one or more embodiments of the disclosure, there is provided a network bandwidth estimation apparatus configured at a service terminal, further including:
in some optional implementations, the model training module is configured to:
group a plurality of model training sample data according to a numerical value of a preset parameter item in the network state parameters;
perform model training respectively based on the grouped model training sample parameters to obtain a plurality of network bandwidth estimation models.

The scope of the disclosure referred to in the present disclosure is not limited to the technical solution formed by the specific combination of the above technical features, and should also cover other technical solutions formed by any combination of the above technical features or their equivalent features without departing from the concept of the above disclosure. For example, the above-described features and the technical features disclosed in the present disclosure having similar functions are substituted with each other to form a solution.

Further, while operations are depicted in a particular order, this should not be understood as requiring that these operations be performed in the particular order shown, or in sequential order. In certain circumstances, multitasking and parallel processing may be advantageous. Likewise, while numerous implementation details are contained in the above discussion, these should not be construed as limitations on the scope of the present disclosure. Some features that are described in the context of separate embodiments can also be implemented in combination in a single embodiment. Conversely, various features that are described in the context of a single embodiment can also be implemented in multiple embodiments separately or in any suitable subcombination.

Although the subject matter has been described in language specific to structural features and/or methodological acts, the subject matter defined in the appended claims is not necessarily limited to the specific features or acts described above. Rather, the specific features and acts described above are merely example forms of implementing the claims.

1. A network bandwidth estimation method applied to a client, comprising:
sending a bandwidth test file to a service terminal, and respectively acquiring network state parameters before and after sending the bandwidth test file, wherein a volume of the bandwidth test file is less than a preset file volume threshold;
determining a first network bandwidth and a second network bandwidth based on the network state parameters and the volume of the bandwidth test file; and
inputting the network state parameters, the first network bandwidth, and the second network bandwidth into a current latest network bandwidth estimation model to obtain a target network bandwidth estimation result,
wherein the current latest network bandwidth estimation model is a model determined based on machine learning of the network state parameters, the first network bandwidth, the second network bandwidth, and an actual network bandwidth corresponding to the target network bandwidth estimation result in all previous network bandwidth estimation processes.

2. The method of claim 1, wherein inputting the network state parameters, the first network bandwidth, and the second network bandwidth into the current latest network bandwidth model to obtain the target network bandwidth estimation result comprises:
determining a target network bandwidth estimation model, which is matched with a parameter numerical value interval where a numerical value of a preset parameter item in the network state parameters is located, in the current latest network bandwidth estimation model according to the numerical value; and
inputting the network state parameters, the first network bandwidth and the second network bandwidth into the target network bandwidth estimation model to obtain the target network bandwidth estimation result.

3. The method of claim 1, wherein determining the first network bandwidth and the second network bandwidth based on the network state parameters and the volume of the bandwidth test file comprises:
determining the first network bandwidth according to the volume of the bandwidth test file and a data transmission round trip latency in the network state parameters; and
inputting the network state parameters into a preset offline bandwidth prediction model, to obtain the second network bandwidth.

4. The method of claim 1, wherein sending the bandwidth test file to the service terminal comprises:
sending the bandwidth test file to the service terminal in response to entering an editing interface of to-be-uploaded video data.

5. The method of claim 1, wherein after sending the bandwidth test file to the service terminal, the method further comprises:
acquiring the current latest network bandwidth estimation model from the service terminal.

6. The method of claim 5, further comprising:
sending the acquired network state parameters, the first network bandwidth and the second network bandwidth obtained by calculation, and an actual network bandwidth corresponding to the target network bandwidth estimation result to the service terminal in each network bandwidth estimation process, so that the service terminal performs training and updating of the network bandwidth estimation model according to the received data.

7. A network bandwidth estimation method applied to a service terminal, comprising:
acquiring network state parameters collected, a first network bandwidth and a second network bandwidth obtained by calculation, and an actual network bandwidth corresponding to a target network bandwidth estimation result, in each network bandwidth estimation process by a client, as model training sample data;
training a network bandwidth estimation model based on the model training sample data; and
sending the trained network bandwidth estimation model to the client, so that the client estimates a target network bandwidth estimation result based on the network bandwidth estimation model.

8. The method of claim 7, wherein training the network bandwidth estimation model based on the model training sample data comprises:
grouping a plurality of model training sample data according to a numerical value of a preset parameter item in the network state parameters; and
performing model training respectively based on the grouped model training sample parameters to obtain a plurality of network bandwidth estimation models.

9-10. (canceled)

11. An electronic device comprising:
at least one processor; and
a non-transitory memory with instructions thereon, wherein the instructions upon execution by the least one processor, cause the least one processor to:
send a bandwidth test file to a service terminal, and respectively acquire network state parameters before and after sending the bandwidth test file, wherein a volume of the bandwidth test file is less than a preset file volume threshold;
determine a first network bandwidth and a second network bandwidth based on the network state parameters and the volume of the bandwidth test file; and
input the network state parameters, the first network bandwidth, and the second network bandwidth into a current latest network bandwidth estimation model to obtain a target network bandwidth estimation result,
wherein the current latest network bandwidth estimation model is a model determined based on machine learning of the network state parameters, the first network bandwidth, the second network bandwidth, and an actual network bandwidth corresponding to the target network bandwidth estimation result in all previous network bandwidth estimation processes.

12. A non-transitory storage medium, with computer-executable instructions stored thereon, the computer-executable instructions, when executed by a computer processor, cause the computer processor to perform the network bandwidth estimation method according to claim 1.

13. An electronic device comprising:
at least one processor;
a non-transitory memory with instructions thereon,
wherein the instructions upon execution by the processor, cause the processor to implement the network bandwidth estimation method according to claim 7.

14. A non-transitory storage medium storing computer-executable instructions, the computer-executable instructions, when executed by a computer processor, cause the processor to perform the network bandwidth estimation method according to claim 7.

15. The electronic device according to claim 11, wherein the processor is further caused to:
determine a target network bandwidth estimation model, which is matched with a parameter numerical value interval where a numerical value of a preset parameter item in the network state parameters is located, in the current latest network bandwidth estimation model according to the numerical value; and
input the network state parameters, the first network bandwidth and the second network bandwidth into the target network bandwidth estimation model to obtain the target network bandwidth estimation result.

16. The electronic device according to claim 11, the processor is further caused to:
determine the first network bandwidth according to the volume of the bandwidth test file and a data transmission round trip latency in the network state parameters; and
input the network state parameters into a preset offline bandwidth prediction model, to obtain the second network bandwidth.

17. The electronic device according to claim 11, wherein the processor is further caused to:
send the bandwidth test file to the service terminal of in response to entering an editing interface of to-be-uploaded video data.

18. The electronic device according to claim 11, wherein the processor is further caused to:
acquire the current latest network bandwidth estimation model from the service terminal.

19. The electronic device according to claim 18, wherein the processor is further caused to:
send the acquired network state parameters, the first network bandwidth and the second network bandwidth obtained by calculation, and an actual network bandwidth corresponding to the target network bandwidth estimation result to the service terminal in each network bandwidth estimation process, so that the service terminal performs training and updating of the network bandwidth estimation model according to the received data.

20. The electronic device of claim 13, wherein the processor is further caused to implement the network bandwidth estimation method according to claim 8.

21. The non-transitory storage medium of claim 14, the computer processor is further caused to perform the network bandwidth estimation method according to claim 8.
